(19) United States
(12) Patent Application Publication
(10) Pub. No.: US 2020/0175855 A1
(43) Pub. Date: Jun. 4, 2020

(54) TRAFFIC INFORMATION SERVICE APPARATUS AND METHOD

(71) Applicants: HYUNDAI MOTOR COMPANY, Seoul (KR); KIA MOTORS CORPORATION, Seoul (KR)

(72) Inventor: Sung Hwan PARK, Seongnam-si (KR)

(21) Appl. No.: 16/389,469

(22) Filed: Apr. 19, 2019

(30) Foreign Application Priority Data
Dec. 3, 2018 (KR) 10-2018-0153950

(51) Int. Cl. G08G 1/01; G06N 5/04

(52) U.S. Cl. CPC G08G 1/0141; G08G 1/0112; G06N 5/046; G08G 1/0133; G08G 1/0129

(57) ABSTRACT

A traffic information service apparatus and a traffic information service method may include a communication device that receives positioning data transmitted from vehicles and a processor that identifies a number of positioning data generated for each target area based on the received positioning data, predicts a traffic situation of a road section associated with each target area based on the number of the generated positioning data for each target area, and provides traffic situation prediction information.

### CROSS-REFERENCE TO RELATED APPLICATION

The present application claims priority to Korean Patent Application No. 10-2018-0153950, filed on Dec. 3, 2018, the entire contents of which is incorporated herein for all purposes by this reference.

### BACKGROUND OF THE INVENTION

### Field of the Invention

The present invention relates to a traffic information service apparatus and a traffic information service method.

### Description of Related Art

A navigation system searches for and guides an optimal route in consideration of a distance from a current location to a destination point and a traffic situation. Since the navigation system performs the route search by accounting for the traffic situation on a road verified at the time of the route search, it is difficult to predict an accurate destination point arrival time because the traffic situation of the road corresponding to the searched route is changed constantly while the vehicle is traveling along the searched route.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a traffic information service apparatus and a traffic information service method, which are configured for providing traffic situation prediction information by predicting a traffic volume on a road associated with a specific area based on the number of positioning data generated in the specific area.

The technical problems to be solved by the present inventive concept are not limited to the aforementioned problems, and any other technical problems not mentioned herein will be clearly understood from the following description by those skilled in the art to which the present invention pertains.

According to various aspects of the present invention, a traffic information service apparatus may include a communication device receiving positioning data transmitted from vehicles and a processor identifying a number of generated positioning data for each target area based on the received positioning data, predicting a traffic situation of a road section associated with the each target area based on the number of the generated positioning data for the each target area, and providing traffic situation prediction information.

The processor selects the target area in advance based on origin destination data included in a route search request message transmitted from the vehicles.

The road section associated with the each target area is a road section, in which a congestion occurrence frequency is equal to or greater than a reference frequency among road sections associated with the target area, and is previously selected.

The processor predicts a time of congestion and an average vehicle speed of the road section associated with the each target area using a congestion prediction model.

The processor analyzes a correlation between the number of the generated positioning data of the each target area and the average vehicle speed of the road section associated with the each target area and generates the congestion prediction model based on a result of analyzing the correlation.

The congestion prediction model is constructed by an autoencoder and an artificial neural network.

The processor processes the positioning data by accounting for a service user scale in the each target area and a road size of a road section associated with the each target area.

The processor provides a congestion notification to a user terminal located in the target area mapped with the traffic situation prediction information.

The processor generates the congestion notification in a form of at least one of visual information, tactile information, or auditory information.

According to various aspects of the present invention, a traffic information service method may include receiving positioning data transmitted from vehicles, identifying a number of generated positioning data for each target area based on the received positioning data, predicting a traffic situation of a road section associated with the each target area based on the number of the generated positioning data for the each target area, and providing a congestion notification service based on a result of predicting the traffic situation of the road section.

The target area is selected in advance based on origin destination data included in a route search request message transmitted from the vehicles.

The road section associated with the each target area is a road section, in which a congestion occurrence frequency is equal to or greater than a reference frequency among road sections associated with the target area, and is previously selected.

The predicting of the traffic situation may include predicting a time of congestion and an average vehicle speed of the road section associated with the each target area using a congestion prediction model.

The congestion prediction model is generated based on a result obtained by analyzing a correlation between the number of the generated positioning data of the each target area and the average vehicle speed of the road section associated with the each target area.

The positioning data are processed by accounting for a service user scale in the each target area and a road size of a road section associated with the each target area.

The providing of the congestion notification service may include providing a congestion notification to a user terminal located in the each target area.

The congestion notification is generated in a form of at least one of visual information, tactile information, or auditory information.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a configuration of a traffic information service system according to an exemplary embodiment of the present invention;

FIG. 2 is a block diagram illustrating a configuration of a vehicle terminal according to an exemplary embodiment of the present invention;

FIG. 3 is a flowchart illustrating a process of generating a traffic congestion prediction model according to an exemplary embodiment of the present invention;

FIG. 4 is a flowchart illustrating a traffic information service method according to an exemplary embodiment of the present invention;

FIG. 5 is a flowchart illustrating a traffic information service method according to various exemplary embodiments of the present invention; and

FIG. 6 is a block diagram illustrating a configuration of a computing system that executes a traffic information service method according to an exemplary embodiment of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Hereinafter, various exemplary embodiments of the present invention will be described in detail with reference to the accompanying drawings. In the drawings, the same reference numerals will be used throughout to designate the same or equivalent elements. Furthermore, a detailed description of well-known features or functions will be ruled out in order not to unnecessarily obscure the gist of the present invention.

In describing elements of exemplary embodiments of the present invention, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

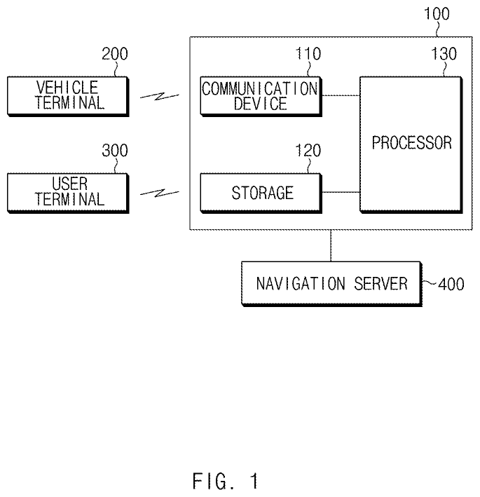

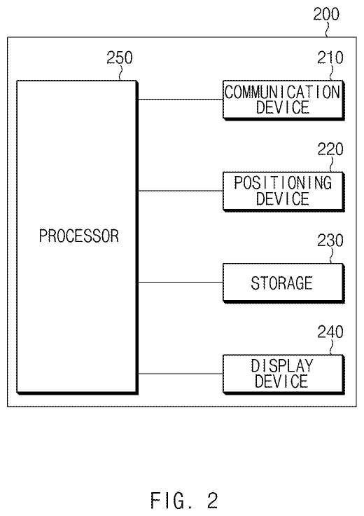

FIG. 1 is a block diagram illustrating a configuration of a traffic information service system according to an exemplary embodiment of the present invention, and FIG. 2 is a block diagram illustrating a configuration of a vehicle terminal according to an exemplary embodiment of the present invention.

Referring to FIG. 1, the traffic information service system includes a traffic information service apparatus 100, a vehicle terminal 200, a user terminal 300, and a navigation server 400.

The traffic information service apparatus 100 predicts a traffic volume on a road associated with a specific area based on the number of positioning data generated in the specific area and provides traffic situation prediction information. The traffic information service apparatus 100 includes a communication device 110, a storage 120, and a processor 130.

The communication device 110 supports a communication with the vehicle terminal 200, the user terminal 300, and/or the navigation server 400. The communication device 110 may use at least one of communication technologies, such as a wired internet, a wireless internet, a mobile communication, and telematics. In an exemplary embodiment of the present invention, as a wired internet technology, a Local Area Network (LAN), a Wide Area Network (WAN), an Ethernet, and/or an Integrated Services Digital Network (ISDN) may be used, and as a wireless internet technology, a Wireless LAN (WLAN), a WiFi, a Wireless broadband (Wibro), and/or a World Interoperability for Microwave Access (Wimax) may be used. As a mobile communication technology, a Code Division Multiple Access (CDMA), a Global System for Mobile communication (GSM), a Long Term Evolution (LTE), and/or an LTE-Advanced may be used.

The communication device 110 may receive route search request information including positioning data (positioning information) and/or an origin destination (OD) data, i.e., departure point information and destination point information, transmitted from the vehicle terminal 200. Furthermore, the communication device 110 may receive the origin destination data (origin destination information) provided from the navigation server 400.

The communication device 110 may transmit a congestion notification to the user terminal 300 in a response to instructions from the processor 130. The congestion notification includes the traffic situation prediction information that includes a congestion zone, a time of congestion, and/or a recommended departure time.

In the exemplary embodiment of the present invention, the positioning information and/or the route search request are provided from the vehicle terminal 200, however, the positioning information and/or the route search request may be provided from the user terminal 300 when a navigation application disposed in the user terminal 300 is used.

The storage 120 may store programs for an operation of the processor 130 and input and/or output data. The storage 120 may be implemented by at least one storage medium (recording medium) among storage media, such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and a web storage.

The storage 120 may store congestion notification service user information and average vehicle speed information for each road section in a database form. The user information may be information related to the user who applied for the congestion notification service and may include user identification information, departure point, destination point, and/or target destination point arrival time. The average vehicle speed information for each road section may include road section identification information, an average vehicle speed by hour of day, an average vehicle speed by day of week, an average vehicle speed by weather condition, and/or an average vehicle speed by unexpected situations.

The storage 120 may store the origin destination data, a selected target area, and a main road (target road) associated with the selected target area. The origin destination data are used to generate a region selection model and a congestion prediction model. Furthermore, the storage 120 may store the region selection model and the congestion prediction model.

The processor 130 may control an overall operation of the traffic information service apparatus 100. The processor 130 may include at least one of an application specific integrated circuit (ASIC), a digital signal processor (DSP), programmable logic devices (PLD), field programmable gate arrays (FPGAs), a central processing unit (CPU), microcontrollers, or microprocessors.

The processor 130 selects the target area and the target road using the region selection model based on the origin destination data. The processor 130 collects the origin destination data transmitted from vehicles through the communication device 110. The processor 130 utilizes the collected origin destination data as input data of the region selection model.

In other words, the processor 130 identifies a frequency of the search request for each predetermined unit area based on the collected origin destination data and selects at least one target area based on the identified search request frequency for each unit area. In an exemplary embodiment of the present invention, the target area may be divided into a departure area and a destination area as areas to be monitored by the traffic information service apparatus 100.

For example, the processor 130 collects the origin destination information from 6 am to 9 am during commuting hours and selects Seongnam-si area (residential area, departure area) in Gyeonggi-do and Gangnam-gu area (working area, destination area) in Seoul-si, where the number of route search requests is more than a predetermined number, as the target area based on the collected origin destination information.

When the target area is selected, the processor 130 selects a predetermined number (for example, two) of road sections having a high congestion occurrence frequency among the road sections associated with the target area as the main roads (main road sections) based on the average vehicle speed information for each road section. In other words, the processor 130 selects the road sections having the congestion occurrence frequency equal to or greater than a reference frequency among the road sections connecting the selected departure area and the destination area.

The processor 130 analyzes a correlation between the number of received positioning data and the average vehicle speed of the main road associated with the target area according to the time for each selected target area. The processor 130 may perform a pre-processing step for processing the positioning data before analyzing the correlation. In an exemplary embodiment of the present invention, the processor 130 processes the positioning data by accounting for a road size and area characteristics since a service user scale in a densely populated area differs from a service user scale in a low populated area and the traffic congestion occurs due to a size of the road even though there is a small floating population.

The processor 130 reflects the analyzed correlation to generate the congestion prediction model. The congestion prediction model is constructed with an autoencoder and an artificial neural network.

As such, the processor 130 may predict the time of congestion and the average vehicle speed of the target road associated with the target area according to the number of generated positioning data for each target area using the generated congestion prediction model. In detail, the processor 130 extracts feature information from the positioning data using the autoencoder and utilizes the extracted feature information as input data of the artificial neural network. The feature information may include information on the specific area where the number of occurrences of the positioning data is equal to or greater than a reference number and information on a main road associated with the specific area. The processor 130 predicts the average vehicle speed and the time of congestion of the main road according to the number of generated positioning data of the target area by use of the artificial neural network. Furthermore, the processor 130 may predict a traffic situation by day of week and a traffic situation by weather condition through a machine learning algorithm.

The processor 130 transmits the traffic situation prediction information to the user located in the target area among the users who have registered a point (location) in the target area as the departure point. The processor 130 transmits the time of congestion and the average vehicle speed of the main road (target road) associated with the target area as the traffic situation prediction information. In the instant case, the processor 130 may transmit the traffic situation prediction information in a form of a short message and/or a push message.

The processor 130 identifies the number of the positioning data generated in the target area, such as a current location of the user requesting the congestion notification service, an area within a radius determined based on the registered departure point, or a unit area to which the user's current position or the registered departure place belongs, at every predetermined time unit. The processor 130 may predict the time of congestion and the average vehicle speed of the road associated with the target area according to the number of generated positioning data when the number of generated positioning data in the target area is equal to or greater than the reference number.

The processor 130 may provide the predicted traffic situation prediction information to the user who utilizes the congestion notification service. The processor 130 may transmit the traffic situation prediction information including the time of congestion and the average vehicle speed of the main road associated with the target area as the congestion notification. In the instant case, the processor 130 may transmit the congestion notification in a form of a short message and/or a push message.

The vehicle terminal 200 may transmit the positioning data and/or the route search request. Referring to FIG. 2, the vehicle terminal 200 includes a communication device 210, a positioning device 220, a storage 230, a display device 240, and a processor 250. The vehicle terminal 200 may be implemented by a navigation terminal, an audio video navigation (AVN) terminal, or a telematics terminal.

The communication device 210 performs a wireless communication with the traffic information service apparatus 100. In an exemplary embodiment of the present invention, at least one of communication technologies, such as a wireless internet, a mobile communication, telematics, and a vehicle communication (vehicle-to-everything, V2X), may be used for the wireless communication. As the V2X technology, a vehicle-to-vehicle (V2V) communication, a vehicle-to-infrastructure (V2I) communication, vehicle-to-nomadic devices communication (V2N), and/or an in-vehicle network communication (IVN) may be applied.

The positioning device 220 measures a current position of the vehicle. The positioning device 220 may measure the position of the vehicle using at least one of positioning techniques, such as a global positioning system (GPS), a dead reckoning (DR), a differential GPS (DPGS), and a carrier phase differential GPS (CDGPS).

The storage 230 may store a software programmed to allow the processor 250 to perform predetermined operations. The storage 230 may store map information and vehicle identification information.

The storage 230 may be implemented by at least one storage medium among storage media, such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and a web storage.

The display device 240 outputs a state of progress and a processing result according to the operation of the processor 250 as visual information. The display device 240 may be implemented by at least one of a liquid crystal display (LCD), a thin film transistor-liquid crystal display (TFT-LCD), an organic light emitting diode (OLED) display, a flexible display, a three-dimensional (3D) display, a transparent display, a head-up display (HUD), a touch screen, or a cluster.

The display device 240 may include a sound output module, such as a speaker, to output audio data. For instance, the display device 240 may display route guide information and may output a voice signal (audio signal) through the speaker.

Furthermore, the display device 240 may be implemented by a touch screen coupled to a touch sensor and may be used as not only an output device but also an input device. The touch sensor may be a touch film or a touch pad.

The processor 250 controls an overall operation of the vehicle terminal 200. The processor 250 may include at least one of an application specific integrated circuit (ASIC), a digital signal processor (DSP), programmable logic devices (PLD), field programmable gate arrays (FPGAs), a central processing unit (CPU), microcontrollers, or microprocessors.

The processor 250 operates the positioning device 220 when the vehicle is started, that is, when a power is supplied to the vehicle terminal 200. The processor 250 measures the current position of the vehicle using the positioning device 220 and transmits the measured current position of the vehicle to the traffic information service apparatus 100 via the communication device 210. In other words, the processor 250 transmits the positioning data measured by the positioning device 220 to the traffic information service apparatus 100.

Furthermore, the processor 250 transmits the route search request including information on the current position of the vehicle (departure point) and the destination point to the traffic information service apparatus 100 and the navigation server 400 when the destination point is set. When the processor 250 receives a searched driving route from the navigation server 400, the processor 250 maps the received driving route in the map information and perform the route guide. The processor 250 determines and outputs the destination point arrival time in consideration of the traffic situation prediction information when receiving the traffic situation prediction information from the traffic information service apparatus 100. In an exemplary embodiment of the present invention, the vehicle terminal 200 determines the destination point arrival time, however, it may not be limited thereto or thereby. That is, the navigation server 400 may determine the destination point arrival time by accounting for the traffic situation prediction information and may provide the determined destination point arrival time to the vehicle terminal 200.

The user terminal 300 may be implemented by an electronic device configured for wireless and/or wired communication, e.g., a smartphone, a tablet computer, a personal digital assistant (PDA), a portable multimedia player (PMP), and/or a notebook computer. Although not shown in figures, the user terminal 300 includes a communication module, a user input module, an output module, a positioning module, a processor, and a memory.

The user terminal 300 may execute a navigation application in a response to a user input provided through the user input module. The user terminal 300 measures the current position of the user terminal 300 using the positioning module when the navigation application is executed. The user terminal 300 may transmit the positioning data measured by the positioning module, i.e., the current position of the user terminal 300, to the traffic information service apparatus 100 through the communication module.

The user terminal 300 may access the traffic information service apparatus 100 through the communication module to request the congestion notification service. The user terminal 300 may register the user identification information, the departure point, the destination point, and the target destination point arrival time in the traffic information service apparatus 100 as the user information when requesting the congestion notification service.

The user terminal 300 may receive the congestion notification including the traffic situation prediction information from the traffic information service apparatus 100. The user terminal 300 may display the received congestion notification on a display screen in a form of popup. As an example, the user terminal 300 may display a notification message of “The traffic is heavy today. We recommend departing 15 minutes earlier than usual” on the display screen. In the instant case, the user terminal 300 may output a warning sound and/or a voice message together.

The navigation server 400 searches an optimal route based on the origin destination data included in the route search request message when receiving the route search request from the vehicle terminal 200 or the user terminal 300. In the instant case, the navigation server 400 may search for the route using the traffic situation prediction information provided from the traffic information service apparatus 100. The navigation server 400 transmits the searched route information to the vehicle terminal 200 or the user terminal 300.

Furthermore, when the navigation server 400 receives the route search request message, the navigation server 400 may collect the origin destination data included in the received route search request message and may provide the collected origin destination data to the traffic information service apparatus 100. Although not shown in figures, the navigation server 400 includes a communication module that communicates with the traffic information service apparatus 100, the vehicle terminal 200, and the user terminal 300, a memory that stores a detailed map, and a processor that searches for and provides the optimal route using the detailed map.

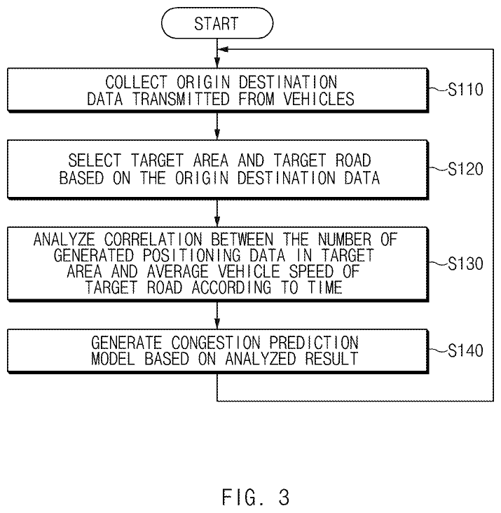

FIG. 3 is a flowchart illustrating a process of generating a traffic congestion prediction model according to an exemplary embodiment of the present invention.

The processor 130 of the traffic information service apparatus 100 collects the origin destination data transmitted from vehicles (S110). When the processor 130 receives the route search request message transmitted from the vehicle terminal 200 or the user terminal 300, the processor 130 extracts the origin destination data included in the received route search request message. Meanwhile, the processor 130 may receive the collected origin destination data from the navigation server 400.

The processor 130 selects the target area and the target road based on the collected origin destination data (S120). The processor 130 analyzes the origin destination data and selects the area, in which the number of occurrences of the route search request is equal to or greater than the reference number, as the target area. In the instant case, the processor 130 may select the departure area and the destination area as one pair. The processor 130 selects the road section, in which the congestion occurrence frequency is equal to or greater than the reference frequency among the road sections that connect the departure area and the destination area, as the target area.

The processor 130 analyzes the correlation between the number of the generated positioning data in the target area and the average vehicle speed of the target road according to the time (S130). In other words, the processor 130 analyzes a variation in the average vehicle speed of the target road associated with the target area depending on the number of the positioning data generated in the target area.

The processor 130 generates the congestion prediction model based on a result of analyzing the correlation (S140). The congestion prediction model may be constructed with the autoencoder and the artificial neural network.

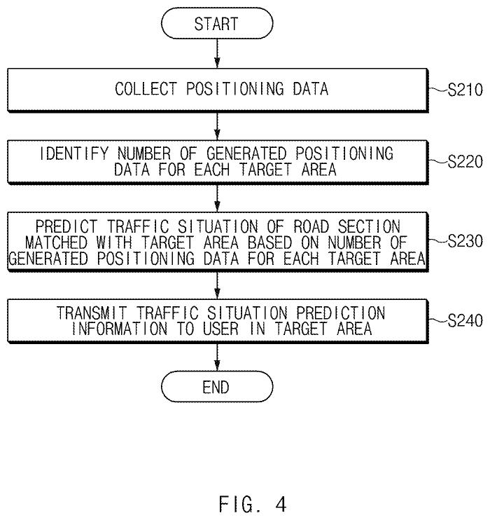

FIG. 4 is a flowchart illustrating a traffic information service method according to an exemplary embodiment of the present invention.

Referring to FIG. 4, the processor 130 of the traffic information service apparatus 100 collects the positioning data through the communication device 110 (S210). The processor 130 collects the positioning data transmitted from the vehicle terminal 200 and/or the user terminal 300. As another way, the processor 130 may receive the positioning data collected by the navigation server 400.

The processor 130 identifies the number of the generated positioning data for each target area based on the collected positioning data (S220). In an exemplary embodiment of the present invention, the target area indicates the target area which is previously selected to be monitored.

The processor 130 predicts the traffic situation of the road section matched with the target area based on the number of the generated positioning data for each target area (S230). In other words, the processor 130 predicts the time of congestion and the average vehicle speed of the road section associated with the departure area based on the number of the positioning data generated in the departure area (e.g., residential area) selected as the area to be monitored. As an example, when 98 cases of the positioning data are generated in the departure area at 7 am, the processor 130 may determine (predict) the congestion time of the specific road section associated with the departure area as one hour after 7 am, which is 8 am.

The processor 130 provides the traffic situation prediction information to the users located in the target area (S240). The processor 130 may transmit the congestion notification including the traffic situation prediction information to the user terminal 300 of the user who is located in the target area and has applied for the congestion notification service.

As such, when the user terminal 300 receives the congestion notification, the user terminal 300 may output a notification corresponding to the congestion notification. In the instant case, the user terminal 300 may output the notification in a form of at least one of information types, such as visual information, tactile information, and auditory information.

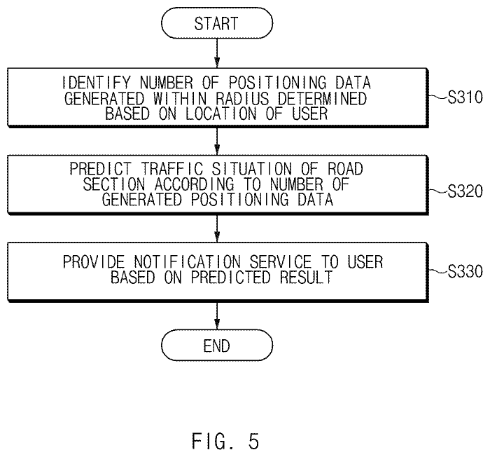

FIG. 5 is a flowchart illustrating a traffic information service method according to various exemplary embodiments of the present invention.

Referring to FIG. 5, the processor 130 of the traffic information service apparatus 100 identifies the number of the positioning data generated within the radius determined based on the location of the user who has applied for the congestion notification service (S310). The processor 130 may set the area within the radius with respect to the current location of the user as the target area. The processor 130 identifies the number of the vehicles that transmits the positioning data in the target area based on the received positioning data collected at a set time intervals. That is, the processor 130 identifies the number of vehicles that starts to operate in the target area.

The processor 130 predicts the traffic situation of the road section associated with the target area including the location of the user based on the identified number of the generated positioning data (S320). The processor 130 determines the time of congestion and the average vehicle speed of the road section associated with the target area according to the number of the generated positioning data in the target area.

The processor 130 provides the congestion notification service to the user based on the predicted traffic situation (S330). The processor 130 may determine the destination point arrival prediction time based on the predicted time of congestion and average vehicle speed of the road section and may transmit the determined destination point arrival prediction time to the user terminal 300 with the congestion notification message. As such, the user terminal 300 may compare the target arrival time registered when the congestion notification service is requested with the destination point arrival prediction time to inform a departure time adjustment. As an example, the user terminal 300 may output the notification message of “The traffic is heavy today. We recommend departing 15 minutes earlier than usual”.

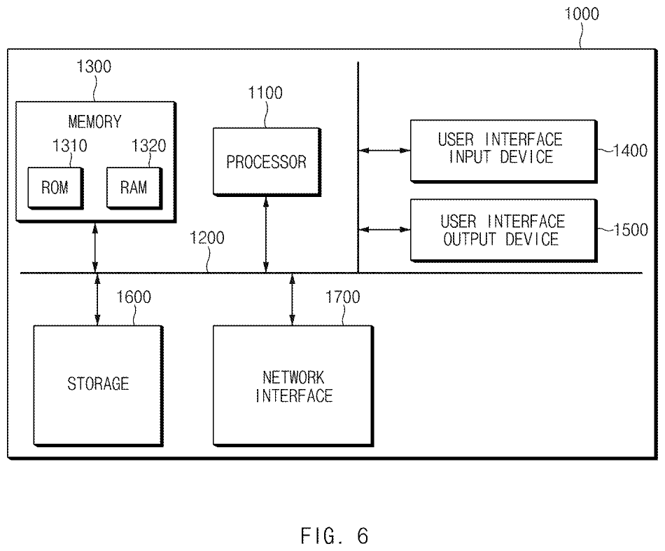

FIG. 6 is a block diagram illustrating a configuration of a computing system that executes a traffic information service method according to an exemplary embodiment of the present invention.

Referring to FIG. 6, the computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device configured for processing instructions stored in the memory 1300 and/or the storage 1600. Each of the memory 1300 and the storage 1600 may include various types of volatile or non-volatile storage media. For example, the memory 1300 may include a read only memory (ROM) 1310 and a random access memory (RAM) 1320.

Thus, the operations of the methods or algorithms described in connection with the exemplary embodiments included in the specification may be directly implemented with a hardware module, a software module, or combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and the storage medium may reside as a separate component in the user terminal.

According to an exemplary embodiment of the present invention, the destination point arrival time may be accurately provided by predicting the traffic volume on the road associated with the specific area based on the number of the positioning data generated in the specific area.

Furthermore, according to an exemplary embodiment of the present invention, since the traffic volume on the road associated with the specific area is predicted based on the number of the positioning data generated in the specific area and the traffic situation prediction information are provided before start driving, the driver may adjust the departure time by accounting for the traffic situation prediction information.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A traffic information service apparatus comprising:
a communication device configured to receive positioning data transmitted from vehicles; and
a processor connected to the communication device and configured to:
identify a number of positioning data generated for each target area based on the received positioning data;
predict a traffic situation of a road section associated with each target area based on the number of the generated positioning data for each target area; and
provide traffic situation prediction information.

2. The traffic information service apparatus of claim 1, wherein the processor is configured to select each target area in advance based on origin destination data included in a route search request message transmitted from the vehicles.

3. The traffic information service apparatus of claim 1, wherein the road section associated with each target area is a road section, in which a congestion occurrence frequency is equal to or greater than a reference frequency among road sections associated with each target area, and is previously selected.

4. The traffic information service apparatus of claim 3, wherein the processor is configured to predict a time of congestion and an average vehicle speed of the road section associated with each target area using a congestion prediction model.

5. The traffic information service apparatus of claim 4, wherein the processor is further configured to:
analyze a correlation between the number of the positioning data generated for each target area and the average vehicle speed of the road section associated with each target area; and
generate the congestion prediction model based on a result of analyzing the correlation.

6. The traffic information service apparatus of claim 5,
wherein the congestion prediction model is constructed by an autoencoder and an artificial neural network, and
wherein the processor extracts feature information from the positioning data using the autoencoder and utilizes the extracted feature information as input data of the artificial neural network.

7. The traffic information service apparatus of claim 1, wherein the processor is configured to process the positioning data by accounting for a service user scale in each target area and a road size of a road section associated with each target area.

8. The traffic information service apparatus of claim 1, wherein the processor is configured to provide a congestion notification to a user terminal located in each target area mapped with the traffic situation prediction information.

9. The traffic information service apparatus of claim 8, wherein the processor is configured to generate the congestion notification in a form of at least one of visual information, tactile information, or auditory information.

10. The traffic information service apparatus of claim 1, wherein the processor is configured to identify the number of the positioning data generated within a radius determined based on a location of a user who has applied for a congestion notification service.

11. A traffic information service method comprising:
receiving, by a processor, positioning data transmitted from vehicles;
identifying by the processor, a number of positioning data generated for each target area based on the received positioning data;
predicting by the processor, a traffic situation of a road section associated with each target area based on a number of the generated positioning data for each target area; and
providing by the processor, a congestion notification service based on a result of predicting the traffic situation of the road section.

12. The method of claim 11, wherein each target area is selected in advance based on origin destination data included in a route search request message transmitted from the vehicles.

13. The method of claim 11, wherein the road section associated with each target area is a road section, in which a congestion occurrence frequency is equal to or greater than a reference frequency among road sections associated with each target area, and is previously selected.

14. The method of claim 11, wherein the predicting of the traffic situation includes predicting a time of congestion and an average vehicle speed of the road section associated with each target area using a congestion prediction model.

15. The method of claim 14, wherein the congestion prediction model is generated based on a result obtained by analyzing a correlation between the number of the positioning data generated for each target area and the average vehicle speed of the road section associated with each target area.

16. The method of claim 14,
wherein the congestion prediction model is constructed by an autoencoder and an artificial neural network, and
wherein the processor extracts feature information from the positioning data using the autoencoder and utilizes the extracted feature information as input data of the artificial neural network.

17. The method of claim 11, wherein the positioning data are processed by accounting for a service user scale in each target area and a road size of a road section associated with each target area.

18. The method of claim 11, wherein the providing of the congestion notification service includes providing a congestion notification to a user terminal located in each target area.

19. The method of claim 18, wherein the congestion notification is generated in a form of at least one of visual information, tactile information, or auditory information.

20. The method of claim 11, wherein the processor is configured to identify the number of the positioning data generated within a radius determined based on a location of a user who has applied for a congestion notification service.
